(19) United States
(12) Patent Application Publication
(10) Pub. No.: US 2003/0057328 A1
(43) Pub. Date: Mar. 27, 2003

(54) Spacecraft having a nonuniform body shape

(76) Inventors: Arthur Maruno, Santa Clara, CA (US); Robert Helmer, Pleasanton, CA (US); Steven Perez, Boulder Creek, CA (US); Francisco Sugui, Sunnyvale, CA (US)

Correspondence Address: Joyce Kosinski, Loral Space and Communications, Ltd., 655 Deep Valley Drive, Suite 303, Rolling Hills Estates, CA, 90274, US

(21) Appl. No.: 09/961,607

(22) Filed: Sep. 24, 2001

(51) Int. Cl. B64G 1/22; B64G 1/00

(52) U.S. Cl. 244/158 R

(57) ABSTRACT

A spacecraft having a body whose shape is not uniform along its major axis. The spacecraft body has a lower portion and an upper portion that are disposed along a major axis of the body. The upper portion is smaller in cross section along the major axis than the lower portion. The nonuniform body shape maximizes various dependent and independent features of the spacecraft. This allows additional equipment to fit within the available launch vehicle volume, increased thermal radiator area/capacity, and increased payload capability, and provides for more and/or larger antennas, for example. The nonuniform features of the spacecraft body thus allow for unique stowage of various appendages on the spacecraft body, and in particular, allows the use of four-sides of the spacecraft structure to stow antennas.

### BACKGROUND

The present invention relates generally to spacecraft or satellites, and more particularly, to a spacecraft having a nonuniform body shape to maximize usage of available launch vehicle volume.

The assignee of the present invention manufactures and deploys communication spacecraft. Such spacecraft have antennas stowed thereon that are deployed once the spacecraft is in orbit. The antennas are used for communication purposes.

A spacecraft structure (body) is typically composed of frame members and panels. The structure is utilized to contain various components that comprise the payload and necessary subsystems to maintain satellite operation. It is also the body to which various appendages are attached, such as solar arrays, antennas, sensors, and the like.

The current art/trend, such as is used on a Lockheed-Martin A2100 A2. Advanced Satellite, for example, is for a 3-axis stabilized satellite structure to take the shape of a rectangular box. The size of the shape has been dictated by the quantity of equipment that needs to be contained in the structure body, the amount of area available for thermal dissipation, and the mass of the structure and the equipment contained therein or attached thereto.

It would be desirable to maximize usage of available launch vehicle volume. Therefore, it is an objective of the present invention to provide for spacecraft whose available launch vehicle volume for carrying its payload and equipment is maximized.

### SUMMARY OF THE INVENTION

To accomplish the above and other objectives, the present invention provides for a spacecraft structure or body that is not uniform along its major axis. Thus, the spacecraft structure has a non-uniform shape along its major axis. The structure of the spacecraft structure or body is similar in appearance to a form developed when two or more boxes of dissimilar size are stacked on top of one another.

The spacecraft body structure provided by the present invention maximizes usage of available launch vehicle volume. The present invention also increases the available payload mounting volume. The nonuniform features of the spacecraft body allow unique stowage of antenna reflectors (use of the four sides of the spacecraft in the nonuniform section). The present invention provides for increased thermal radiator area/capacity. The present invention allows unique stowage of antennas. The present invention permits the use of four-sides of a spacecraft structure for stowing antennas.

The present invention allows a spacecraft to maximize the use of the available launch vehicle volume. The present invention allows the ability to extend the spacecraft into the conical section of the launch vehicle fairing. Since the present invention allows the extension of the spacecraft structure, this in turn increases the available payload mounting volume and increases the thermal radiator area/capacity. Additionally, since the spacecraft structure is extended and non-uniform in shape, this feature allows for the unique stowage of various appendages, including antennas, and the like.

The present invention allows the ability to package more and/or larger reflectors and communication equipment to enhance payload performance. The present invention allows balanced growth of spacecraft systems and capabilities.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates a partially exposed perspective view of a spacecraft in accordance with the principles of the present invention with a non-uniform shape;

FIG. 2 illustrates the spacecraft shown in FIG. 1 having the antennas deployed; and

FIG. 3 illustrates a side view of the spacecraft shown in FIG. 1 stowed within the fairing envelope of a launch vehicle prior to deployment.

### DETAILED DESCRIPTION

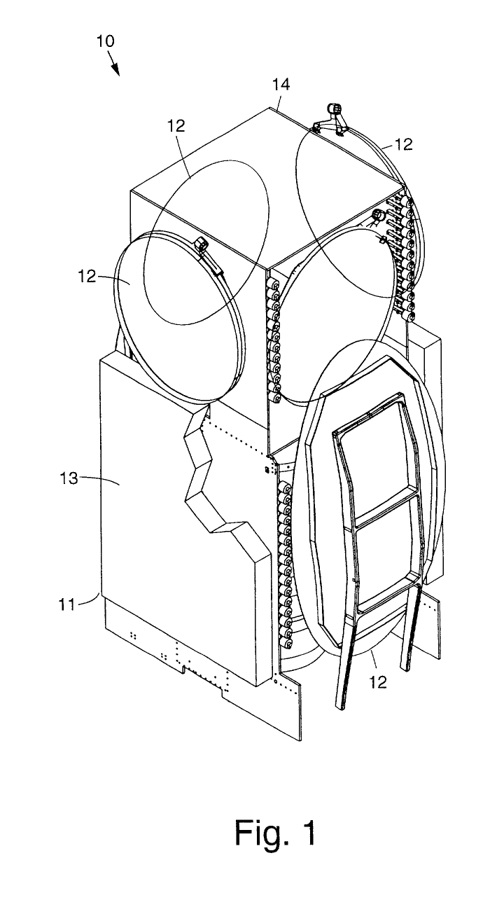

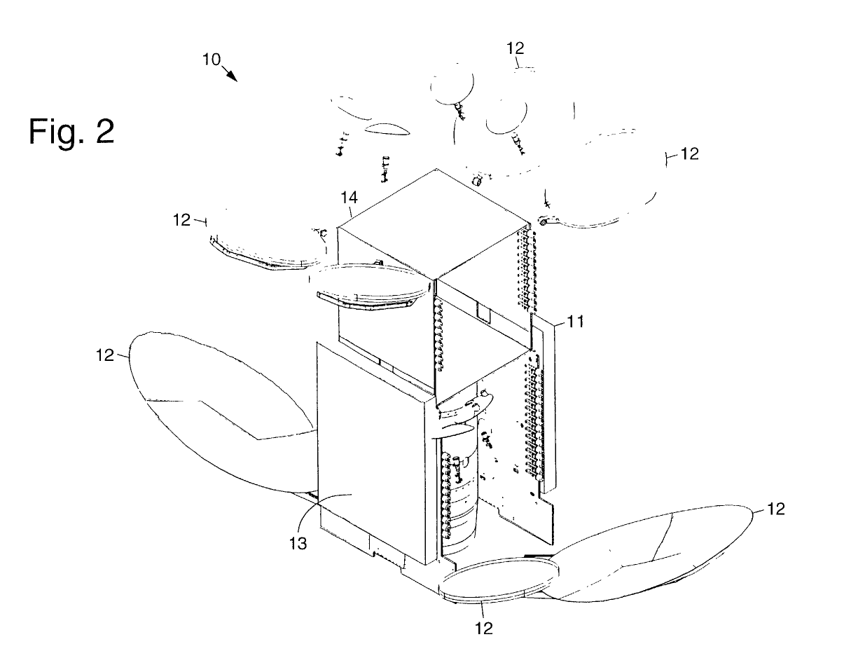

Referring to the drawing figures, FIG. 1 illustrates a partially exposed perspective view of a spacecraft 10 or satellite 10 in accordance with the principles of the present invention having a non-uniform shape. FIG. 1 also shows stowed antennas 12 on the satellite 10. FIG. 2 illustrates the spacecraft 10 shown in FIG. 1 with the antennas 12 deployed. Portions of the structures securing the various antennas 12 to the body 11 are not shown.

The spacecraft 10 comprises a body 11 having a nonuniform shape. The body 11 has a lower portion 13 and an upper portion 14 that are disposed along a major axis of the body 11. The upper portion 14 is smaller in cross section than the lower portion 13.

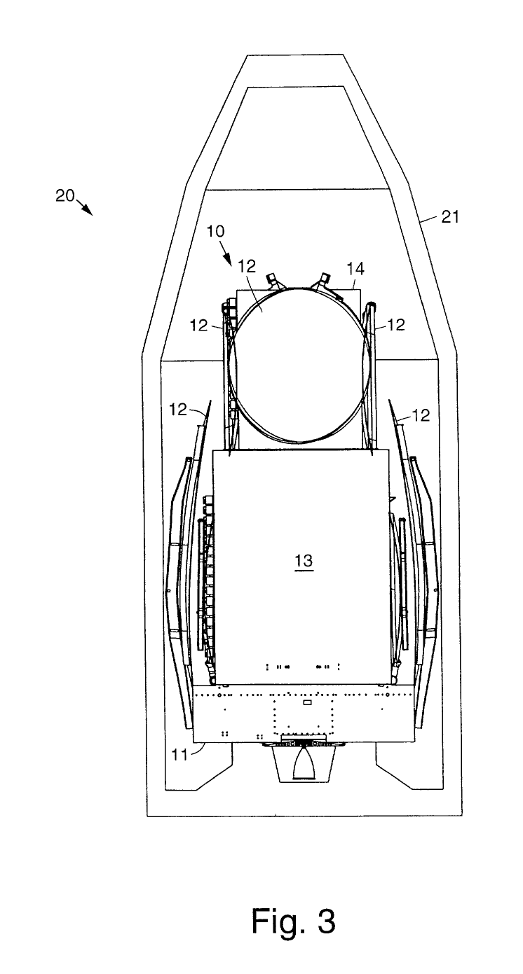

The shape of the body 11 is thus stepped along the major axis of the body 11 and spacecraft 10. This allows the satellite 10 to better fit within the available launch vehicle volume, which it typically located in a nose cone 21 of a launch vehicle 20 (FIG. 3).

FIG. 3 illustrates a side view of the satellite 10 shown in FIG. 1 stowed within a fairing envelope or nose cone 21 of the launch vehicle 20 prior to deployment. The nose cone 21 of the launch vehicle 20 is rounded and tapered toward the forward end of the launch vehicle 20, as is shown in FIG. 3.

As is shown in FIGS. 1 and 3, antennas 12 are stowed on each of the four sides of the upper portion 14 of the body 11 during launch and prior to deployment. This arrangement of stowed antennas 12 has not been possible using conventional spacecraft body designs.

Thus, in accordance with the present invention, the spacecraft body 11 is not uniform along its major axis and thereby maximizes various dependent and independent features of the spacecraft 10. This allows equipment to fit within the available launch vehicle volume, increases thermal radiator area and/or capacity. increases payload capacity, and provides for more and/or larger antennas, for example. The nonuniform features thus allow for unique stowage of various appendages on the body 11 of the spacecraft 10, and in particular, allows for the use of four-sides of the spacecraft body 11 for stowing antennas.

Thus, a spacecraft having a nonuniform body shape that maximizes usage of available launch vehicle volume has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. A spacecraft comprising:
a body having a nonuniform cross section along a major axis of the body.

2. The spacecraft recited in claim 1 wherein the body has a lower portion and an upper portion that are disposed adjacent to each other along a major axis of the body, and wherein the upper portion is smaller in cross section along the major axis than the lower portion.

3. The spacecraft recited in claim 1 wherein the upper and lower portions of the body have rectangular cross sections.

4. The spacecraft recited in claim 1 wherein the upper and lower portions of the body have square cross sections.

5. The spacecraft recited in claim 1 wherein the upper portion of the body has an antenna disposed on more than two sides thereof.

6. The spacecraft recited in claim 1 wherein the body has at least one antenna disposed on each side thereof.

7. The spacecraft recited in claim 1 wherein the nonuniform cross section of the body maximizes usage of available volume of a launch vehicle that carries the spacecraft.
